(19) United States
(12) Patent Application Publication
(10) Pub. No.: US 2013/0215034 A1
(43) Pub. Date: Aug. 22, 2013

(54) EXTRACTION METHOD FOR MULTI-TOUCH FEATURE INFORMATION AND RECOGNITION METHOD FOR MULTI-TOUCH GESTURES USING MULTI-TOUCH FEATURE INFORMATION

(71) Applicants: Chi Min Oh, Gwangju (KR); Yung Ho Seo, Gwangju (KR); Jun Sung Lee, Gwangju (KR); Jong Gu Kim, Jeollanam-do (KR); Chil Woo Lee, Gwangju (KR)

(72) Inventors: Chi Min Oh, Gwangju (KR); Yung Ho Seo, Gwangju (KR); Jun Sung Lee, Gwangju (KR); Jong Gu Kim, Jeollanam-do (KR); Chil Woo Lee, Gwangju (KR)

(73) Assignee: INDUSTRY FOUNDATION OF CHONNAM NATIONAL UNIVERSITY, Gwangju (KR)

(21) Appl. No.: 13/882,157

(22) PCT Filed: Nov. 22, 2010
(86) PCT No.: PCT/KR10/08229

§ 371 Date: Apr. 26, 2013

(30) Foreign Application Priority Data
Oct. 29, 2010 (KR) 10-2010-0107284

(51) Int. Cl. G06F 3/01

(52) U.S. Cl. CPC G06F 3/017
USPC 345/163; 345/173

(57) ABSTRACT

The present invention relates to an extraction method for multi-touch feature information and a recognition method for multi-touch gestures using the multi-touch feature information, and more specifically, to the extraction method for multi-touch feature information and recognition method for multi-touch gestures using the multi-touch feature information, wherein: multi-touch feature information, which does not depend on the number of touch points, is extracted; and the accuracy in gesture recognition is improved by using the extracted multi-touch feature information.

### CROSS REFERENCE TO RELATED APPLICATIONS AND CLAIM OF PRIORITY

This patent application is a National Phase application under 35 U.S.C. §371 of International Application No. PCT/KR2010/008229, filed Nov. 22, 2010, which claims priority to Korean Patent Application No. 10-2010-0107284 filed Oct. 29, 2010, entire contents of which are incorporated herein by reference.

### BACKGROUND

1. Technical Field

The present invention relates, in general, to a method of extracting multi-touch feature information and a method of recognizing multi-touch gestures using the multi-touch feature information and, more particularly, to a method of extracting multi-touch feature information and a method of recognizing multi-touch gestures using the multi-touch feature information, which can extract multi-touch feature information independent of the number of touch points and can improve accuracy and the degree of freedom in recognition of gestures using the extracted multi-touch feature information.

2. Description of the Related Art

Multi-touch technology denotes technology related to human-computer interaction (HCI) and has recently attracted attention by enabling a touch to be made through cooperation between users, and applications related to education, entertainment, and broadcasting have been steadily developed.

Meanwhile, multi-touch technology can be classified into multi-touch feature extraction technology for extracting multi-touch features and multi-touch gesture recognition technology for recognizing touch gestures using the extracted multi-touch features. Generally, multi-touch feature extraction technology refers to technology for extracting motion depending on the number and locations of touch points, and changes in the locations of the touch points.

Further, multi-touch gestures are classified into gestures dependent on the number or locations of touch points, and gestures dependent on the motion of the touch points. The gestures dependent on the motion of the touch points include movement, zoom-in/zoom-out, and rotation gestures, and the gestures dependent on the number or locations of the touch points are gestures for redefining the gestures dependent on motion in various meanings and then improving the degree of freedom.

That is, conventional recognition of multi-touch gestures is highly dependent on the number of touch points, and so if two touch points are simultaneously moved, a case where it is impossible to recognize such a gesture as a movement gesture occurs, or if the number of touch points defined to be recognized changes as if a plurality of touch points simultaneously move far away from current locations, a case where it is impossible to recognize such a gesture as a zooming gesture occurs, and thus the development of technology capable of recognizing gestures regardless of the number of touches is urgently required.

### SUMMARY

As a result of making research and effort so as to extract multi-touch features less dependent on the number of touches and recognize gestures using the extracted multi-touch features, the present inventors have developed the technical configurations of a method of extracting multi-touch feature information and a method of recognizing multi-touch gestures using the multi-touch feature information, which extract one piece of touch graph information, having pieces of location information of touch points and pieces of edge information indicative of information about connections to other touch points within a predetermined radius around each touch point as elements, as multi-touch feature information, and which recognize multi-touch gestures, so that the degree of freedom in definition and recognition of gestures can be improved and the accuracy of recognition can be enhanced, with the result that the present invention has been completed.

Accordingly, an object of the present invention is to provide a method of extracting multi-touch feature information, which is less dependent on the number of touches.

Another object of the present invention is to provide a method of recognizing multi-touch gestures, which recognizes multi-touch gestures using extracted multi-touch feature information, thus defining various gestures and improving the accuracy of gesture recognition.

Objects of the present invention are not limited to the above-described objects, and other objects, not described here, will be more clearly understood by those skilled in the art from the following detailed description.

In order to accomplish the above objects, the present invention provides a method of extracting multi-touch feature information, the method extracting multi-touch feature information indicating features of changes in a plurality of touch points, including a first step of receiving location information of touch points from a touch panel, a second step of connecting touch points located within a predetermined radius around each touch point to each other in a one-to-one correspondence, and generating pieces of edge information, each composed of pieces of location information of two touch points connected to each other, a third step of generating touch graph information having pieces of location information and pieces of edge information of all touch points connected to each other as elements, and extracting the touch graph information as the multi-touch feature information, and a fourth step of receiving updated location information from the touch panel after the location information has been updated, and updating the touch graph information based on the updated location information.

In a preferred embodiment, the updated touch graph information at the fourth step may include previous touch graph information.

In a preferred embodiment, the first step may include steps of 1-1) receiving a touch image, in which the touch points are indicated, from the touch panel, and 1-2) extracting touch vertices indicative of locations of points having highest touch strengths from an area in which the touch points are indicated, and obtaining locations of the touch vertices as pieces of location information of the respective touch points.

In a preferred embodiment, the radius at the second step may be set to a distance corresponding to one of values ranging from 7[cm] to 13[cm].

In a preferred embodiment, the touch graph information may be calculated by the following Equation 1 and may be then generated and updated,

G=(V, E)

V={X_{i,t}}

E={(X_{i,t}, X_{j,t}) } [Equation 1]

where G denotes touch graph information, V denotes a set of pieces of location information of all touch points located in the touch graph information, E denotes a set of pieces of edge information located in the touch graph information, and X_{i,t} and X_{j,t} denote location coordinate values of touch points connected to each other within the radius.

Further, the present invention provides a computer-readable storage medium for storing a to program for executing the multi-touch feature information extraction method on a computer.

Furthermore, the present invention provides a method of recognizing multi-touch gestures including a fifth step of extracting touch graph information using the multi-touch feature information extraction method, and obtaining movement distances at which individual touch points are moved and movement directions in which the touch points are moved by accessing the touch graph information, and a sixth step of, if individual touch points in identical touch graph information are moved in an identical direction within an identical range, recognizing that the touch points in the identical touch graph information are moved.

In a preferred embodiment, the fifth step may be configured to calculate X-axis movement distances and Y-axis movement distances of the respective touch points and then obtain motion vectors of the respective touch points, and the sixth step may be configured to obtain an inner product of the motion vectors of the respective touch points in the identical touch graph information, and if the inner product is ‘1’ within the identical range, recognize that the touch points in the identical touch graph information are moved.

Furthermore, the present invention provides a method of recognizing multi-touch gestures including a fifth step of extracting touch graph information using the multi-touch feature information extraction method, and obtaining edge distances indicative of distances between touch points of each piece of edge information in identical touch graph information by accessing the touch graph information, and a seventh step of, if all of the edge distances are increased by a critical value or more, recognizing that the touch points in the identical touch graph information make a zoom-in gesture of moving far away from each other, whereas if all of the edge distances are decreased by the critical value or more, recognizing that the touch points in the identical touch graph information make a zoom-out gesture of being close to each other.

Furthermore, the present invention provides a method of recognizing multi-touch gestures including a fifth step of extracting touch graph information using the multi-touch feature information extraction method, and averaging coordinate values of touch points in identical touch graph information to obtain center coordinates by accessing the touch graph information, a sixth step of aligning an X axis with the center coordinates and obtaining direction angles of the touch points with respect to a direction of the X axis corresponding to ‘0’ degree, and a seventh step of, if all of the direction angles of the touch points are increased by a critical angle or more, recognizing that the touch points are rotated in a counterclockwise direction, whereas if all of the direction angles of the touch points are decreased by the critical angle or more, recognizing that the touch points are rotated in a clockwise direction.

Furthermore, the present invention provides a method of recognizing multi-touch gestures including a fifth step of extracting touch graph information using the multi-touch feature information extraction method, and counting a number of touch points in identical touch graph information by accessing the touch graph information, and a sixth step of determining whether touch points have been newly generated or eliminated in the identical touch graph information, and recognize that a click gesture of a mouse is made based on a number of touch points that have been generated or eliminated.

In a preferred embodiment, the step of counting the number of touch points may further include step 5-1) determining whether there are changes in locations of the touch points in the identical touch graph information, and the step of recognizing the click gesture of the mouse may be configured to recognize that the drag gesture of the mouse is made if the number of touch points is not changed and there are changes in locations of the touch points.

Further, the present invention provides a computer-readable storage medium for storing a program for executing the multi-touch gesture recognition method on a computer.

The present invention has the following excellent advantages.

First, in accordance with the method of extracting multi-touch feature information according to the present invention, there is an advantage in that multi-touch features are composed of location information and edge information of touch points within a predetermined area, rather than the number of touch points, thus providing various types of multi-touch feature information when recognizing touch gestures.

Further, in accordance with the method of recognizing multi-touch gestures according to the present invention, multi-touch gestures may be defined using changes in the locations of touch points and changes in edge information within a predetermined area, or relations between touch points within the edge information, based on extracted multi-touch feature information without depending on the number of touch points, thus greatly improving the degree of freedom in the definition of gestures and enhancing the accuracy of multi-touch recognition.

### BRIEF DESCRIPTION OF DRAWINGS

FIGS. 1 and 2 are diagrams showing a method of extracting multi-touch feature information according to an embodiment of the present invention;

FIG. 3 is a diagram showing a first example of a method of recognizing multi-touch gestures according to another embodiment of the present invention;

FIG. 4 is a diagram showing a second example of the multi-touch gesture recognition method according to another embodiment of the present invention; and

FIG. 5 is a diagram showing a third example of the multi-touch gesture recognition method according to another embodiment of the present invention.

### DETAILED DESCRIPTION

As the terms used in the present invention, typical terms currently and widely used have been selected wherever possible, but, in specific cases, terms arbitrarily selected by the applicant are also used, and in this case, the meanings of the terms should be determined in consideration of meanings described or used in the detailed description of the invention, rather than merely considering the simple names of the terms.

Hereinafter, technical configuration of the present invention will be described in detail with reference to preferred embodiments shown in the attached drawings.

However, the present invention may be embodied in other forms without being limited to the embodiments described here. The same reference numerals are used throughout the present specification to designate the same components.

A method of extracting multi-touch feature information according to an embodiment of the present invention is a method of extracting multi-touch feature information indicative of the features of touches, that is, a basis for the recognition of multi-touch gestures.

In other words, the multi-touch feature information may be defined as features related to changes in the states of a plurality of touch points.

Further, the multi-touch feature information extraction method according to the embodiment of the present invention is performed by a program capable of actually extracting multi-touch feature information on a computer.

Furthermore, the program may be a program comprised of a program instruction, a local data file, and a local data structure, alone or in combination, and may also be a program implemented in high-level language code that may be executed by the computer using an interpreter or the like, as well as machine language code created by a complier.

Furthermore, the program may be stored in a computer-readable storage medium and read by the computer to execute the functionality thereof, and the medium may be a device designed and configured especially for the present invention, or may be known to and used by those skilled in the art of computer software and may be, for example, a magnetic medium such as a hard disk, a floppy disk, and magnetic tape, an optical recording medium such as a Compact Disk (CD) or a Digital Versatile Disk (DVD), a magneto-optical recording medium enabling both magnetic recording and optical recording to be performed, and a hardware device especially configured to store and execute program instructions, such as Read Only Memory (ROM), Random Access Memory (RAM), and flash memory, alone or in combination.

Furthermore, the program may be stored in a server system capable of transmitting information over a communication network, such as the Intranet or the Internet, and may be transmitted to the computer, as well as being readable by the computer via the above medium. The server system may also provide a platform enabling the computer to access the server system and the program to be executed on the server system, without transmitting the program to the computer.

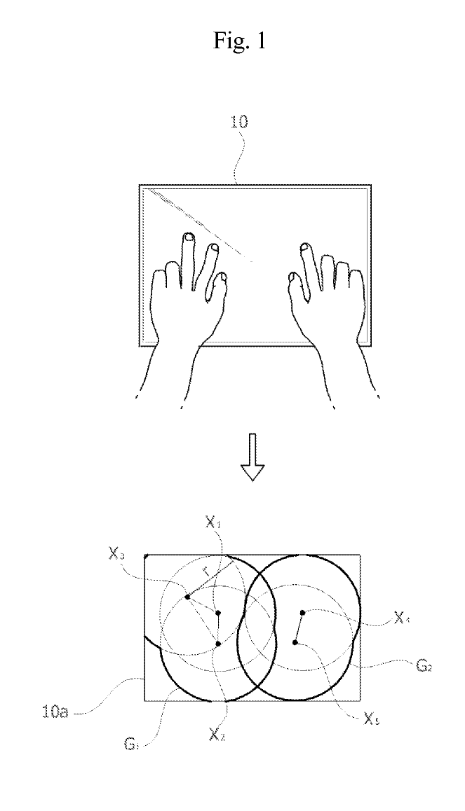

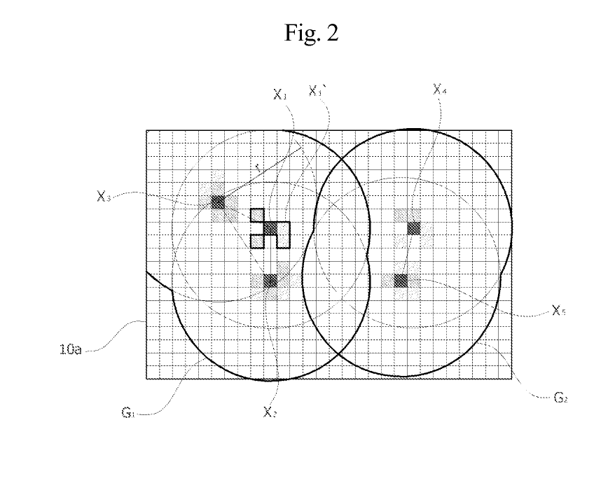

Referring to FIGS. 1 and 2, in the multi-touch feature information extraction method according to the embodiment of the present invention, pieces of location information of touch points X₁, X₂, X₃, X₄, and X₅ are input from a touch panel 10.

Further, the touch panel 10 may directly transmit the pieces of location information of the touch points X₁, X₂, X₃, X₄, and X₅ or may input a two-dimensional (2D) touch image 10a in which the touch points X₁, X₂, X₃, X₄, and X₅ are indicated.

Furthermore, the touch panel 10 may be a medium-/large-sized touch panel using an ultrasonic scheme, an infrared scheme, an optical scheme or the like, as well as a small-sized panel using a resistive or capacitive scheme.

That is, any type of panel may be sufficiently used as the touch panel 10 as long as it may directly input the 2D location information of the touch points X₁, X₂, X₃, X₄, and X₅ or may input the touch image 10a.

Further, the touch image 10a input from the touch panel 10 may actually be a 2-bit monochrome image or an 8-bit grayscale image, or may also be an image obtained by converting the location information of touch points input from the touch panel 10 into the image.

Furthermore, in order to obtain the location information of the touch points X₁, X₂, X₃, X₄, and X₅ from the touch image 10a, a procedure of obtaining touch vertices which are points having the highest touch strength from a touch area X₁′ in which the individual touch points are indicated, and extracting the touch vertices as 2D location information of the touch points X₁, X₂, X₃, X₄, and X₅ is performed.

Further, predetermined identifications (ID) required to identify the touch points are assigned to the touch points X₁, X₂, X₃, X₄, and X₅ via a labeling procedure.

Next, touch points located within a predetermined radius (r) around each of the touch points X₁, X₂, X₃, X₄, and X₅ of the touch image 10a are found.

Further, the length of the radius (r) is selected as one of values ranging from 7[cm] to 13 [cm] which are half of the maximum distances which can be touched on average when persons stretch their hands.

When the first touch point X₁, the second touch point X₂, and the third touch point X₃ shown in FIGS. 1 and 2 are described by way of example, the second touch point X₂ and the third touch point X₃ which are touch points located within the predetermined radius (r) around the first touch point X₁ are found, and the first touch point X₁ is individually connected to the second touch point X₂ and the third touch point X₃ in a one-to-one correspondence.

Here, the connection in the one-to-one correspondence means that one piece of edge information having the first touch point X₁ and the second touch point X₂ as elements and another piece of edge information having the first touch point X₁ and the third touch point X₃ as elements are generated.

Next, the edge information of the second touch point X₂ connected to the third touch point X₃ is generated.

Such a procedure is performed on all of the touch points X₁, X₂, X₃, X₄, and X₅.

That is, three pieces of edge information, that is, first edge information (X₁, X₂) having the first touch point X₁ and the second touch point X₂ as elements, second edge information (X₂, X₃) having the second touch point X₂ and the third touch point X₃ as elements, and third edge information (X₁, X₃) having the first touch point X₁ and the third touch point X₃ as elements are generated as pieces of edge information around the first touch point X₁.

If two touch points are present within the radius, two pieces of location information and one piece of edge information are generated, and if four touch points are present within the radius, four pieces of location information and six pieces of edge information are generated.

Next, touch graph information having pieces of location information and edge information of all touch points connected to each other as elements is generated.

Further, the touch graph information may be represented by the following Equation 1:

G=(V, E)

V={X_{i,t}}

E={(X_{i,t}, X_{j,t}) } [Equation 1]

where G denotes touch graph information, V denotes the location information of touch points located within a single radius, E denotes edge information located within the single radius, X_{i,t} denotes 2D location coordinate values of respective touch points at a current time, and X_{j,t} denotes location coordinate values of other touch points matching each touch point at the current time.

FIG. 1, for example, shows that current touch graph information has two pieces of touch graph information including first touch graph information G₁ composed of three touch points X₁, X₂, and X₃ and three pieces of edge information (X₁, X₂), (X₂, X₃), and (X₁, X₃), and second touch graph information G₂ composed of two touch points X₄ and X₅ and one piece of edge information (X₄, X₅).

Next, the touch image 10a is updated by and input from the touch panel 10, the pieces of touch graph information G₁ and G₂ are updated by repeating the above-described steps, and a set of the touch graph information G₁ and G₂ is extracted as the multi-touch feature information. Further, the updated touch graph information includes previous touch graph information.

That is, the multi-touch feature information extracted according to the embodiment of the present invention is generated by combining the locations of touch points associated with each other within a predetermined radius and pieces of connection information therebetween, and so it can be used to more flexibly define or recognize touch gestures compared to conventional multi-touch feature information that depends on the location of a single touch point or the number of touch points.

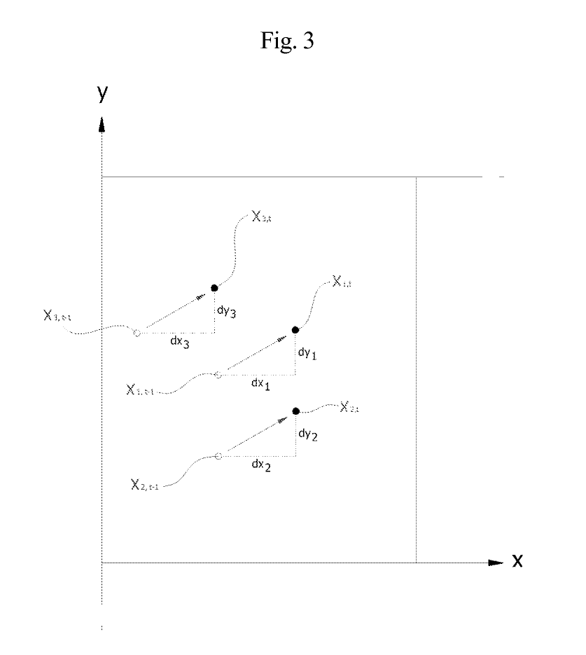

FIGS. 3 to 6 are diagrams showing examples of a method of recognizing multi-touch gestures according to another embodiment of the present invention, wherein the multi-touch gesture recognition methods according to another embodiment of the present invention are methods of recognizing a change in touch so as to assign events, such as movement, zoom-in, rotation, clicking, or dragging, to a touched area, and wherein the pieces of touch graph information G₁ and G₂ extracted by the multi-touch feature information extraction method according to the embodiment of the present invention are used.

Referring to FIG. 3, a first example of the multi-touch gesture recognition method according to another embodiment of the present invention is configured to define and recognize a multi-touch movement, wherein recognition is performed for each piece of touch graph information.

Hereinafter, first graph information G₁ will be described by way of example for the sake of convenience of description.

First, movement distances at which the first touch point X₁, the second touch point X₂, and the third touch point X₃ are respectively moved and movement directions in which they are respectively moved are obtained by accessing the first touch graph information G₁.

Next, when the first touch point X₁, the second touch point X₂, and the third touch point X₃ are moved in the same direction and are moved at distances in the same ratio, all of the first touch point X₁, the second touch point X₂, and the third touch point X₃ are recognized to make a movement gesture.

Further, the movement gesture is determined by calculating a movement gesture likelihood function given in the following Equation 2:

$${P}_{1} ( {G}_{1 , t \vert t - 1} \vert {Z}_{1} ) \approx {\prod }_{{X}_{i , t} ∈ {G}_{1 , t}} \frac{{[ d x , d y ]}^{T}}{‖ {[ d x , d y ]}^{T} ‖} \qquad Equation 2$$

where P₁ denotes the likelihood function of a movement gesture Z₁, dx denotes the movement distance of each touch point along an X axis and dy denotes the movement distance of each touch point along a Y axis.

Further, the X-axis and Y-axis movement distances may be calculated from the previous location information X_{1,t-1}, X_{2,t-1}, and X_{3,t-1} of the touch points.

That is, when an inner product of the movement directions of all touch points is close to ‘1’, it can be determined that the first touch point X₁, the second touch point X₂, and the third touch point X₃ are moved in the same direction.

However, it is apparent that the movement gesture may be calculated by obtaining distances at which respective touch points are actually moved and angles of the touch points with respect to the X axis, as well as the X-axis and Y-axis movement distances of the respective touch points.

Further, in Equation 2, since the recognition of movement gestures of the respective touch points of the touch graph information G₁ has been described as an example, reference character ‘G₁’ has been used, but, in practice, the determination of individual movement gestures has been performed on all pieces of touch graph information G₁ and G₂.

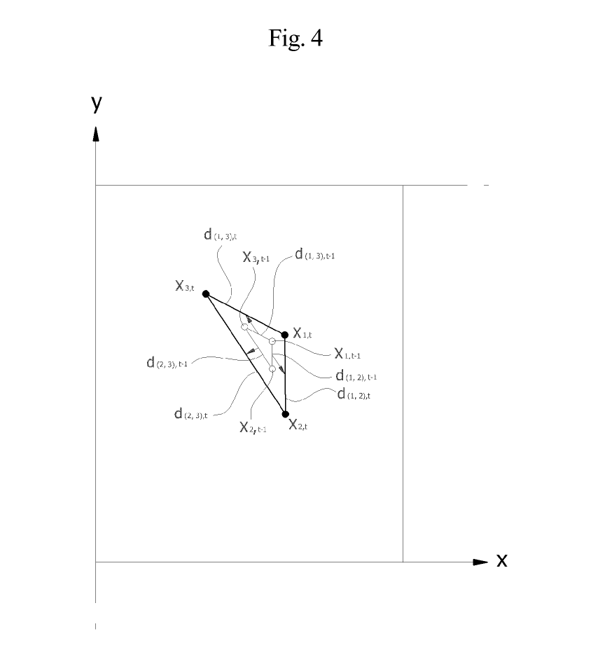

FIG. 4 is a diagram showing a second example of the multi-touch gesture recognition method according to another embodiment of the present invention, wherein the second example of the multi-touch gesture recognition method is a method of recognizing and determining a multi-touch zooming gesture.

Hereinafter, a description will also be made using the first touch graph information G₁ by way of example for the sake of convenience of description.

First, edge distances d_{(1,2),t}, d_{(1,3),t}, and d_{(2,3),t} which are distances of touch points X_{1,t}, X_{2,t}, and X_{3,t} in respective pieces of edge information are obtained by accessing the first touch graph information G₁.

Next, when the edge distances d_{(1,2),t}, d_{(1,3),t}, and d_{(2,3),t} are compared with the previous edge distances d_{(1,2),t-1}, d_{(1,3),t-1}, and d_{(2,3),t-1} of the touch points X_{1,t-1}, X₂ₜ₋₁, and X_{3,t-1} in previous edge information, if the edge distances d_{(1,2),t}, d_{(1,3),t}, and d_{(2,3),t} have become greater than the previous edge distances d_{(1,2),t-1}, d_{(1,3),t-1}, and d_{(2,3),t-1} by a critical distance or more, the touch points X_{1,t} X_{2,t}, and X_{3,t} in the first touch graph information G₁ are recognized to make a zoom-in gesture, whereas if all of the edge distances d_{(1,2),t}, d_{(1,3),t}, and d_{(2,3),t} have become less than the previous edge distances d_{(1,2),t-1}, d_{(1,3),t-1}, and d_{(2,3),t-1} by a critical distance or more, the touch points X_{1,t}, X_{2,t}, and X_{3,t} in the first touch graph information G₁ are recognized to make a zoom-out gesture.

Further, zooming gestures including the zoom-in gesture and the zoom-out gesture are determined by calculating a zooming gesture likelihood function given in the following Equation 3:

$${P}_{2} ( {G}_{1 , t \vert t - 1} \vert {Z}_{2} ) \approx {\prod }_{{X}_{( i , j ) , t} ∈ {G}_{1 , t}} u ( \vert {d}_{( i , j ) , t - 1} - {d}_{( i , j ) , t} \vert - {S}_{min} ) \qquad Equation 3$$

where P₂ denotes the likelihood function of a zooming gesture Z₂, u(x) denotes a unit function, d denotes an edge distance, and Sₘᵢₙ denotes a critical distance.

That is, when the edge distances d_{(1,2),t}, d_{(1,3),t}, and d_{(2,3),t} of the first touch graph information G₁ are changed by a critical distance or more, a probability of ‘1’ is calculated and the touch points X_{1,t}, X_{2,t}, and X_{3,t} in the first touch graph information G₁ are recognized to make a zoom-in gesture.

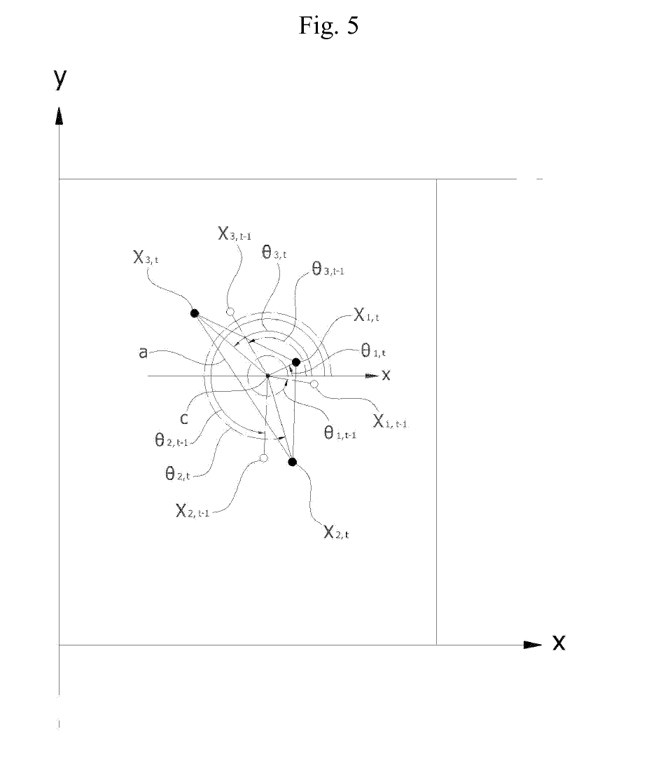

FIG. 5 is a diagram showing a third example of the multi-touch gesture recognition method according to another embodiment of the present invention, wherein the third example of the multi-touch gesture recognition method is a method of recognizing and determining a multi-touch rotation gesture.

Hereinafter, a description will be made using the first touch graph information G₁ by way of example for the sake of convenience of description.

First, center coordinates of all touch points in the first touch graph information G₁ are obtained by accessing the first touch graph information G₁. Here, the center coordinates may be obtained as the averages of the coordinates of all the touch points in the first touch graph information G₁.

Next, an X axis is aligned with the center coordinates c, and direction angles θ_{1,t}, θ_{2,t}, and θ_{3,t} formed between the direction of the X axis corresponding to ‘0’ degree and the individual touch points X_{1,t}, X_{2,t}, and X_{3,t} and direction angles θ_{1,t-1}, θ₂ₜ₋₁, and θ_{3,t-1} formed between the direction of the X axis corresponding to ‘0’ degree and the touch points X_{1,t-1}, X_{2,t-1}, and X_{3,t-1} at previous locations of the respective touch points X_{1,t}, X_{2,t}, and X_{3,t} are obtained.

Next, when the direction angles θ_{1,t}, θ_{2,t}, and θ_{3,t} of the respective touch points X_{1,t}, X_{2,t}, and X_{3, t} are compared with the direction angles θ_{1,t-1}, θ_{2,t-1}, and θ_{3,t-1} of the touch points X_{1,t-1}, X_{2,t-1}, and X_{3,t-1} at the previous locations, if all of the current direction angles θ_{1,t}, θ_{2,t}, and θ_{3,t} of the respective touch points X_{1,t}, X_{2,t}, and X_{3,t} have become greater than the previous direction angles θ_{1,t-1}, θ_{2,t-1}, and θ_{3,t-1} by a critical angle or more, the first touch point X_{1,t}, the second touch point X_{2,t}, and the third touch point X_{3,t} are recognized to make a counterclockwise rotation gesture, whereas if all of the current direction angles θ_{1,t}, θ_{2,t}, and θ_{3,t} of the respective touch points X_{1,t}, X_{2,t}, and X_{3,t} have become less than the previous direction angles by the critical angle or more, the first touch point X₁,ₜ, the second touch point X_{2,t}, and the third touch point X_{3,t} are recognized to make a clockwise rotation gesture.

Further, the rotation gesture is determined by calculating a rotation gesture likelihood function given in the following Equation 4:

$${P}_{3} ( {G}_{1 , t \vert t - 1} \vert {Z}_{2} ) \approx {\prod }_{{X}_{i , t} ∈ {G}_{1 , t}} u ( \vert {θ}_{i , t - 1} - {θ}_{i , t} \vert - {R}_{min} ) \qquad Equation 4$$

where P₃ denotes a likelihood function for a rotation gesture Z₃, u(x) denotes a unit function, and Rₘᵢₙ denotes a critical angle.

That is, when all the touch points X_{1,t}, X_{2,t}, and X_{3,t} of the first touch graph information G₁ are rotated at the critical angle or more, a probability becomes ‘1’ or ‘0’, and then the rotation gesture may be defined and recognized.

Furthermore, the multi-touch gesture recognition method according to another embodiment of the present invention may recognize gestures, such as the click or drag gesture of a mouse, in addition to movement, zooming, and rotation gestures. First, the number of current touch points X_{1,t}, X_{2,t}, and X_{3,t}, the number of touch points that are moved for a predetermined time period Δt, and the number of touch points that are not moved for the predetermined time period Δt are counted by accessing the first touch graph information G₁.

Next, when a predetermined number of touch points are newly generated and eliminated for the predetermined time period, the touch points may be recognized to make the click gesture of the mouse.

Furthermore, when a predetermined number of touch points make the movement gesture Z₁ or the rotation gesture Z₃ for the predetermined time period, the touch points are recognized to make the drag gesture of the mouse.

For example, the number of current touch points X_{1,t}, X_{2,t}, and X_{3,t} may be defined as a likelihood function for a number gesture, as given in the following Equation 5, and the number of current touch points X_{1,t}, X_{2,t}, and X_{3,t} which are moved or are not moved may be defined as a likelihood function for a number-of-movements gesture, as given in the following Equation 6, and may be used to recognize the click or drag gesture of the mouse.

P₄(G_{1,t|t-1}|Z₄, K)≈∫δ(N−k) Equation 5

In this case, P₄ denotes a likelihood function for a number gesture Z₄, δ(x) denotes a delta function, N denotes the number of current touch points X_{1,t}, X_{2,t}, and X_{3,t}, and k denotes the number of touch points desired to be defined. That is, when the user defines the number of touch points as k and the number of actual touch points is k, the number gesture likelihood function becomes ‘1.’

P₅(G_{1,t|t-1}|Z₅, l,o)≈∫δ(N−k)(Nₘₒᵥₑ−l)(N_{stable}−o)) Equation 5

In this case, P₅ denotes a likelihood function for a number-of-movements gesture Z₅, ‘1’ denotes the number of touch points that are moved for a predetermined time period, and ‘o’ denotes the number of touch points that are not moved for the predetermined time period. That is, if ‘k’ touch points are currently present, and ‘1’ touch points are moved and ‘o’ touch points are not moved for the predetermined time period, the likelihood function for the number-of-movements gesture becomes ‘1.’

Further, the click gesture of the mouse may be defined by a click gesture likelihood function obtained by combining the number gesture likelihood function with the number-of-movements likelihood function, as given in the following Equation 7, and then the click gesture of the mouse may be recognized.

f_{click}(G_{1,t|t-1})=P₄(G_{1,t|t-1}|Z₄, K=1)P₅(G_{1,t|t-1}|Z₅, l=1, o=0) Equation 7

That is, if the number of touch points currently present in the first touch graph information G₁ is 1, and one touch point is generated and eliminated for a predetermined time period, the click gesture of the mouse may be recognized.

Further, the drag gesture of the mouse may be defined by combining the likelihood function for the movement gesture Z₁, the likelihood function for the rotation gesture Z₃, and the likelihood function for the number gesture Z₄, as given in the following Equation 8, and may then be recognized.

f_{drag}(G_{1,t|t-1})=P₁(G_{1,t|t-1}|Z₁)P₄(G_{1,t|t-1}|Z₄, K=2)+P₃(G_{1,t|t-1}|Z₃) P₄(G_{1,t|t-1}|Z₄, K=2) Equation 8

That is, if the touch points in the first touch graph information G₁ currently make a movement gesture or a rotation gesture, and the number of touch points is two, the drag gesture of the mouse may be recognized.

However, the click gesture or the drag gesture of the mouse may be defined by the user by combining likelihood functions P₁, P₂, P₃, P₄, and P₅ in various manners, and the likelihood functions P₁, P₂, and P₃ for the movement, zooming, and rotation gestures may also be defined by the user using the touch graph information G in various manners.

Therefore, there is an advantage in that the degree of freedom in the definition and recognition of a multi-touch is very high, and multi-touch gestures may be defined in various manners, thus greatly improving the accuracy of the recognition of multi-touch gestures.

Although the preferred embodiments of the present invention have been illustrated and described, the present invention is not limited by the above embodiments, and various modifications and changes can be implemented by those skilled in the art to which the present invention pertains, without departing from the spirit of the invention.

A method of extracting multi-touch feature information and a method of recognizing multi-touch gestures using the multi-touch feature information according to embodiments of the present invention may be utilized in the field of Human Computer Interaction (HCI) in various manners

1. A method of extracting multi-touch feature information indicating features of changes in a plurality of touch points, comprising:
receiving location information of touch points from a touch panel;
connecting touch points located within a predetermined radius around each touch point to each other in a one-to-one correspondence, and generating pieces of edge information, each comprised of pieces of location information of two touch points connected to each other;
generating touch graph information having the pieces of location information and the pieces of edge information of all touch points connected to each other as elements, and extracting the touch graph information as the multi-touch feature information; and
receiving updated location information from the touch panel, and updating the touch graph information based on the updated location information.

2. The method of claim 1, wherein the updated touch graph information includes the touch graph information before the updating.

3. The method of claim 1, wherein said receiving the location information of the touch points from the touch panel comprises:
receiving a touch image, in which the touch points are indicated, from the touch panel; and
extracting touch vertices indicative of locations of points having highest touch strengths from an area in which the touch points are indicated, and obtaining locations of the touch vertices as pieces of location information of the respective touch points.

4. The method of claim 1, wherein the predetermined radius at the second step is set to a distance corresponding to one of values ranging from 7 cm to 13 cm.

5. The method of claim 1, wherein the touch graph information is generated and updated by the calculation with the following Equation 1:
G=(V, E)
V={X_{i,t}}
E={(X_{i,t}, X_{j,t}) } [Equation 1]
where G denotes the touch graph information, V denotes a set of pieces of location information of all touch points located in the touch graph information, E denotes a set of pieces of edge information located in the touch graph information, and X_{i,t} and X_{j,t} denote location coordinate values of the touch points connected to each other within the radius.

6. A computer-readable storage medium for storing a program for executing the multi-touch feature information extraction method of claim 1 on a computer.

7. A method of recognizing multi-touch gestures., comprising:
extracting touch graph information using the method claim 1, and obtaining movement distances at which individual touch points are moved and movement directions in which the touch points are moved by accessing the touch graph information; and
determining if individual touch points in identical touch graph information are moved in an identical direction within an identical range to recognize that the touch points in the identical touch graph information are moved.

8. The method of claim 7, wherein:
said extracting the touch graph information is configured to calculate X-axis movement distances and Y-axis movement distances of the respective touch points and then obtain motion vectors of the respective touch points, and
the determining is configured to obtain an inner product of the motion vectors of the respective touch points in the identical touch graph information, and if the inner product is ‘1’ within the identical range, recognize that the touch points in the identical touch graph information are moved.

9. A computer-readable storage medium for storing a program for executing the multi-touch gesture recognition method set forth in claim 8 on a computer.

10. A method of recognizing multi-touch gestures, comprising:
extracting touch graph information using the multi-touch feature information extraction method of claim 1, and obtaining edge distances indicative of distances between touch points of each piece of edge information in identical touch graph information by accessing the touch graph information; and
determining if all of the edge distances are increased or decreased by a critical value or more, to recognize that the touch points in the identical touch graph information make a zoom-in gesture of moving far away from each other if increased by critical value or more, and that the touch points in the identical touch graph information make a zoom-out gesture of being close to each other if decreased by the critical value or more.

11. A computer-readable storage medium for storing a program for executing the multi-touch gesture recognition method set forth in claim 10 on a computer.

12. A method of recognizing multi-touch gestures comprising:
extracting touch graph information using the multi-touch feature information extraction method of claim 1, and averaging coordinate values of touch points in identical touch graph information to obtain center coordinates by accessing the touch graph information;
aligning an X axis with the center coordinates and obtaining direction angles of the touch points with respect to a direction of the X axis corresponding to ‘0’ degree; and
determining if all of the direction angles of the touch points are increased or decreased by a critical angle or more to recognize that the touch points are rotated in a counterclockwise direction if increased by the critical angle or more, and that the touch points are rotated in a clockwise direction if decreased by the critical angle or more.

13. A computer-readable storage medium for storing a program for executing the multi-touch gesture recognition method set forth in claim 12 on a computer.

14. A method of recognizing multi-touch gestures, comprising:
extracting touch graph information using the multi-touch feature information extraction method of claim 1, and counting a number of touch points in identical touch graph information by accessing the touch graph information; and
determining whether touch points have been newly generated or eliminated in the identical touch graph information to recognize that a click gesture of a mouse is made based on a number of touch points that have been generated or eliminated.

15. The multi-touch gesture recognition method of claim 14, wherein:
said extracting the touch graph information further comprises determining whether there are changes in locations of the touch points in the identical touch graph information
to recognize that a drag gesture of the mouse is made if the number of touch points is not changed and there are changes in locations of the touch points.

16. A computer-readable storage medium for storing a program for executing the multi-touch gesture recognition method set forth in claim 15 on a computer.
